(19) United States
(12) Patent Application Publication
(10) Pub. No.: US 2005/0055855 A1
(43) Pub. Date: Mar. 17, 2005

(54) Sign

(75) Inventor: David Richard Vernon-Dier, Durham (GB)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: GDRC Limited

(21) Appl. No.: 10/820,626

(22) Filed: Apr. 8, 2004

(30) Foreign Application Priority Data
Apr. 8, 2003 (GB) 0308034.5

(51) Int. Cl. G09F 13/00

(52) U.S. Cl. 40/431

(57) ABSTRACT

A sign having a rotating display and illuminated with lights. The lights are powered though a slip-ring device on a frame and drive shaft of the display. The power can be from the mains, or alternative energy sources such as solar panels or a dynamo. The rotation can be wind-powered, or motorised. The signs can be used a information display signs or as decorative signs, for example as Christmas decorations.

### CROSS REFERENCE TO RELATED APPLICATIONS

The present application claims priority under 35 USC § 119 to United Kingdom Patent Application No. 0308034.5 filed on Apr. 8, 2003.

### TECHNICAL FIELD

The present invention relates to signs and in particular spinning signs.

### BACKGROUND OF THE INVENTION

Spinning signs are well known and are generally used for advertising. A flat or an S-shaped display board is connected to a fixed frame at central upper and lower points. The board acts as a sail and is driven by the wind. The board rotates about the central axis and the sign is observed at varying degrees of motion depending upon the available wind.

### SUMMARY OF THE INVENTION

The object of the present invention is to provide an improved sign incorporating a rotating display board.

According to the invention there is provided a sign including:
a fixed section including
   at least one pair of bearings and
   means for attachment to a power supply
a rotatable section having
   means for attachment to the bearings on the fixed section, enabling rotation of the one section about the other,
   lights on the fixed and/or rotatable section(s) being powered from the power supply,
   means for supplying power to fixed and/or rotatable section(s).

Advantageously the means for supplying power to the second section may include a slip-ring device.

In one embodiment, the rotatable section is an inner section. In this embodiment, an outer section of the slip ring assembly is attached to the fixed section and power supply thereon and remains static, and an inner section is affixed to the rotatable section and moves therewith.

In another embodiment, the rotatable section is an outer section In this embodiment, a central slip ring assembly is attached to the fixed section remaining static thereon, while bushes of the slip ring are attached to the rotatable section and rotate therewith.

Additionally, an electronic controller may be provided to animate the lights.

While in many embodiments, the power for rotation of the rotatable section will come from ambient wind, in some embodiments the device may include a motor to drive the rotation.

In some embodiments, the power for the lights may be provided from the mains. Preferably, power may also be provided from an alternative source, such as a solar panel or a dynamo, powered by rotation of the rotatable section.

Generally, where an alternative energy source is used to power the sign, the sign will include batteries charged by the alternative source. Additionally the sign will also be provided with change over circuitry to change the power source to the mains if the charge on the batteries decreases past a predetermined threshold.

In some embodiments, the sign may also include a photodiode to detect the ambient light levels, and allow power to pass to the lights only when the light level drops below a certain predetermined threshold.

Usually the device will further include a frame or bracket from mounting thereof.

### BRIEF DESCRIPTION OF THE DRAWINGS

To help understanding of the invention, a specific embodiment thereof will now be described by way of example and with reference to the accompanying drawings, in which:

FIG. 1 is a front view of a sign ac cording to the invention;

FIG. 2 is a view of the slip-ring assembly according to the invention;

FIG. 3 is a front view of a frame according to a second embodiment of the invention;

FIG. 4 is a front view of a frame according to a third embodiment of the invention;

FIGS. 5a-5e are a series of designs for the display board according to the invention;

FIG. 6 is a sign according to a fourth embodiment of the invention;

FIG. 7 is a device according to a fifth embodiment of the invention;

FIG. 8 is a front view of a device according to a sixth embodiment of the invention;

FIG. 9 is a front view of the inner section of the embodiment of FIG. 8;

FIG. 10 is a front view of the outer section of the embodiment of FIG. 8; and

FIG. 11 is an impression of the embodiment of FIG. 8 in use.

### DETAILED DESCRIPTION

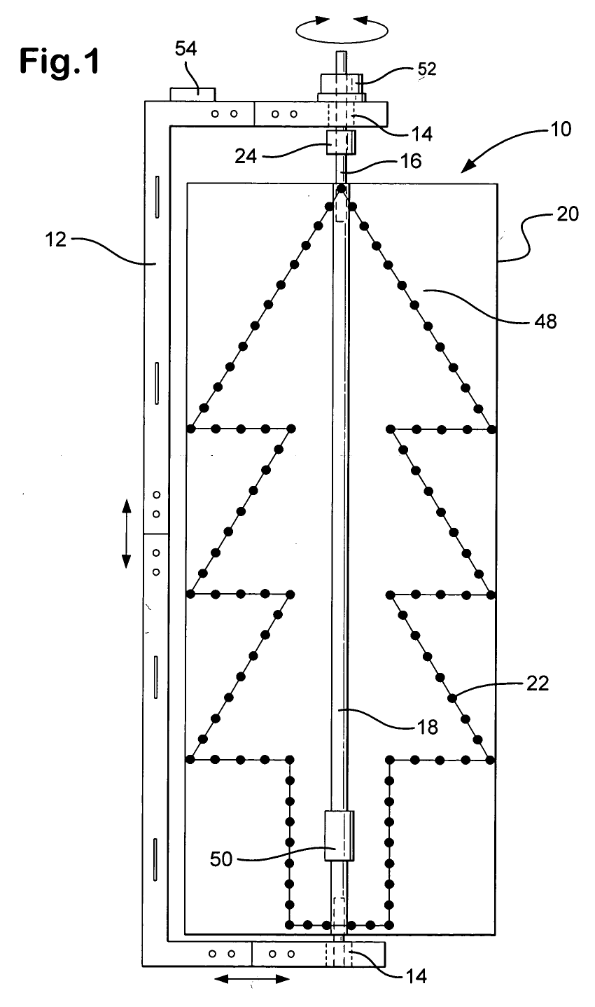

Referring to FIG. 1, thereshown is a sign 10 according to one embodiment of the invention. The sign includes a frame 12 accommodating a pair of bearing assemblies 14 connected to primary drive shaft 16.

A display board 20 having a display shaft 18 is connected to the primary drive shaft 16 on the frame 12. Thus the display board 20 is held in the frame 12, but is free to rotate like a sale when blown by the wind.

According to the invention, lights 22 are provided on the display board 20, to create an illuminated display. To power the lights a slip-ring assembly 24 is provided on the frame 12, to allow power to pass from the stationary frame to the rotating display board.

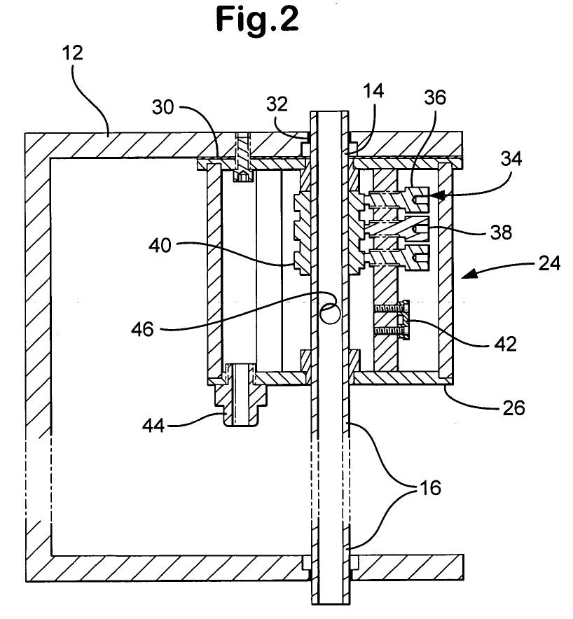

As shown in FIG. 2, the slip-ring assembly 24 is provided in a housing 26 to protect the same from the elements. The housing comprises a tubular cover 28, sealed at each end by a sealing gasket 30. It is also sealed to the frame and drive shaft with a further seal 32. The assembly 24 comprises an outer section 34, including brush holders 36 and brush terminals 38, which remain static within the housing 26. The assembly 24 also includes an inner section 40 that is attached to the drive shaft 16 and moves therewith. This includes the slip rings. The assembly 24 also includes a cable clamp 42, an IP 66 cable gland 44 and an exit 46 for a power cable into the shaft 16. Thus the electricity passes via bushes onto the slip rings and through the drive shaft to the display board.

Referring again to FIG. 1, the display board is provided with an image 48 and lights 22 highlighting the image. An electronic controller 50 is also provided to animate the lights 22, for example to make some of the lights flash, or different lights to turn on at different times. As discussed below, in daylight the image will be the most visible part of the sign and thus the image will generally be high quality printed graphics.

In some embodiments, both sides of the board will be provided with an identical image and lights. However, in other embodiments one side of the board is provided with an image and appropriate lights, while the other side is provided with an advertisement. Again this advertisement will generally be high quality printed graphics.

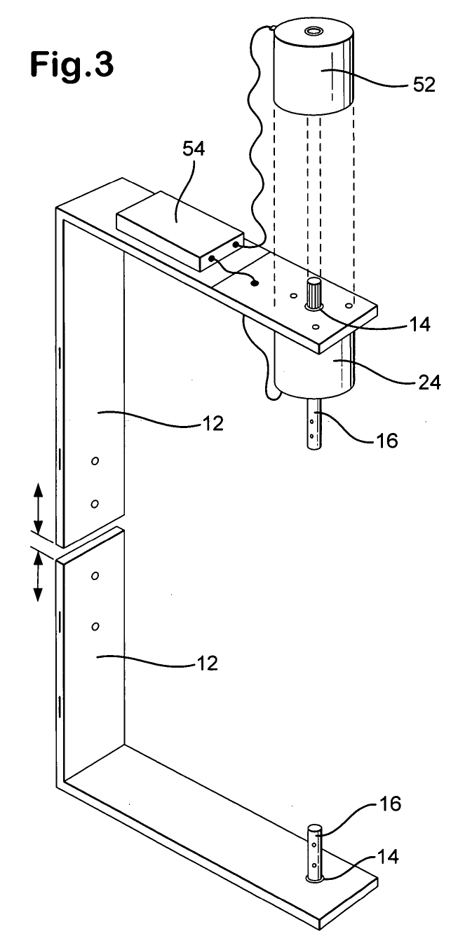

In the embodiment shown in FIG. 3, the energy required to power the light bulbs is harnessed from the wind as it rotates the sign. A dynamo or generator 52 is fixed to the drive shaft 16. As the drive shaft rotates, the dynamo converts the power therefrom into electricity, which is used to charge a battery pack 54. The battery pack includes batteries, together with charging and changeover circuitry, and may also include an addition power supply, such as a connection to the mains. Thus in the event of the dynamo not generating sufficient power and the charge in the batteries dropping below a predetermined threshold.

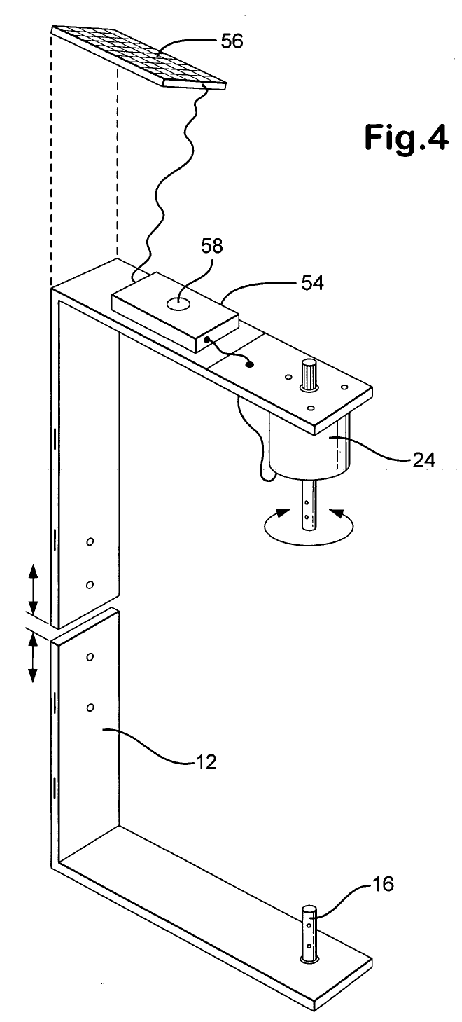

In a further embodiment, shown in FIG. 4, power is harnessed from solar panels 56. As in the previous embodiment, the solar panels 56 are used to charge a battery pack. As before the pack includes batteries, charging and change over circuitry, and may also include a connection to the mains electricity supply in the event that the battery charge drops below a predetermined level. As shown in this embodiment, although this feature could be applied to other embodiments, a photodiode 58 is provided, which will allow the flow of electricity to power the lights, when the ambient light level is below a pre-determined threshold. This results in a more efficient use of electricity, powering the lights only when they will be sufficiently visible to create an impact.

In use, the frame will be mounted in different positions depending upon its use. For an advertising display, the frame may be free standing, and placed for example on the side of the road, or on a building facade. For use as a Christmas decoration for example, the frame may be mounted on a lamp-post or other structure from which such decorations are mounted. As shown in FIG. 1, the frame may include attachment slots, for attaching the frame to a lamp-post or the like.

At time of good light levels, in particularly on bright days, the most visible and noticeable part of the sign will be the image 48 on the display board 20. The lights 22 will also be visible of course, but due to the ambient light levels their impact will be low. As the wind blows, the display board 20 on the sign 10 will spin, making the image 48 stand out. However, in low light levels, for example at night or on dull days, the most visible part of the sign will be the lights on the display board. As the wind blows and the sign turns, this action will alter the appearance of the lights 22. Rather than spots of light the lights will appear as traces, and thus a visual illusion of a three-dimensional image will occur. The faster the sign rotates, the stronger appearance of the illusion will be.

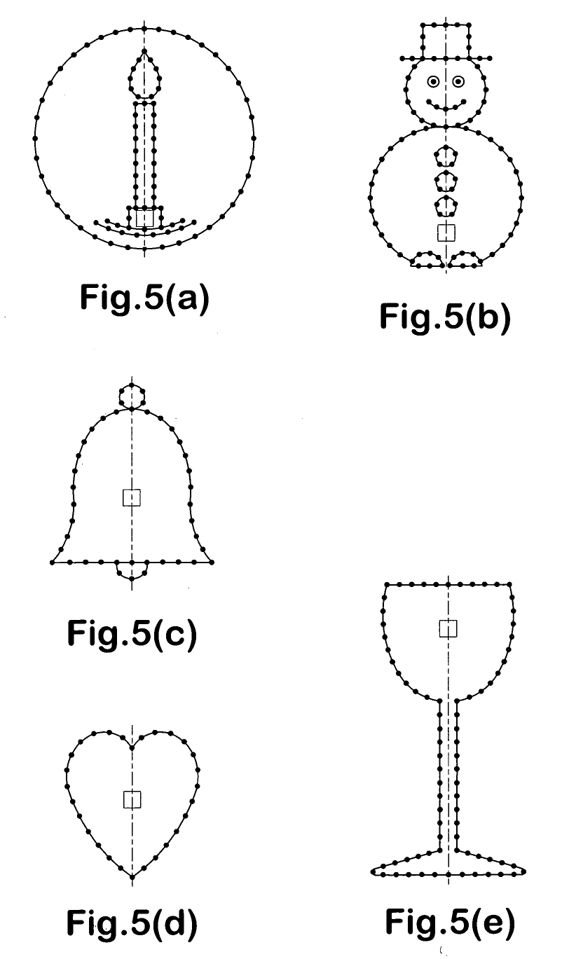

Clearly for rotation of light sources to create an illusion of a 3-D image, the image will have to be symmetrical. The image can be created by the rotation of half the image, or by the whole image. For use as a display in high light levels where the contrast with the light sources on the image will be low, it is sensible to use a whole image, so that viewers have an attractive picture to see when the light contrast is low. FIG. 5 shows examples of suitable images the display board. Christmas decorations, including candles 5a, snowmen 5b and bells 5c are all symmetrical images and are suitable for this purpose. Other images that are symmetrical and could be used on advertising signs are hearts 5d and wine glasses 5e.

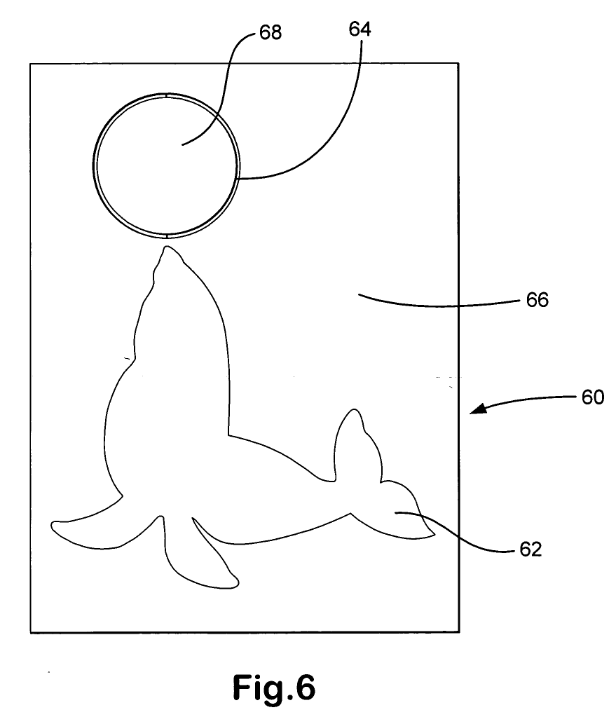

However, in some situations, a user may wish to display a non-symmetrical image, and this clearly cannot be rotated to provide an illusion of the image in 3-D. However, if the image were to incorporate a portion that is symmetrical, this portion of the image alone could be provided as the spinning display board, with the rest of the image forming the frame. FIG. 6 shows a sign 60 in having a picture of a seal 62 holding a ball 64. The image of the seal 62 is provided as a frame 66, with the ball 64 alone, being provided on the display board 68. Thus as the display board spins, the illusion of a 3-D ball is created, balanced by a 2-D seal.

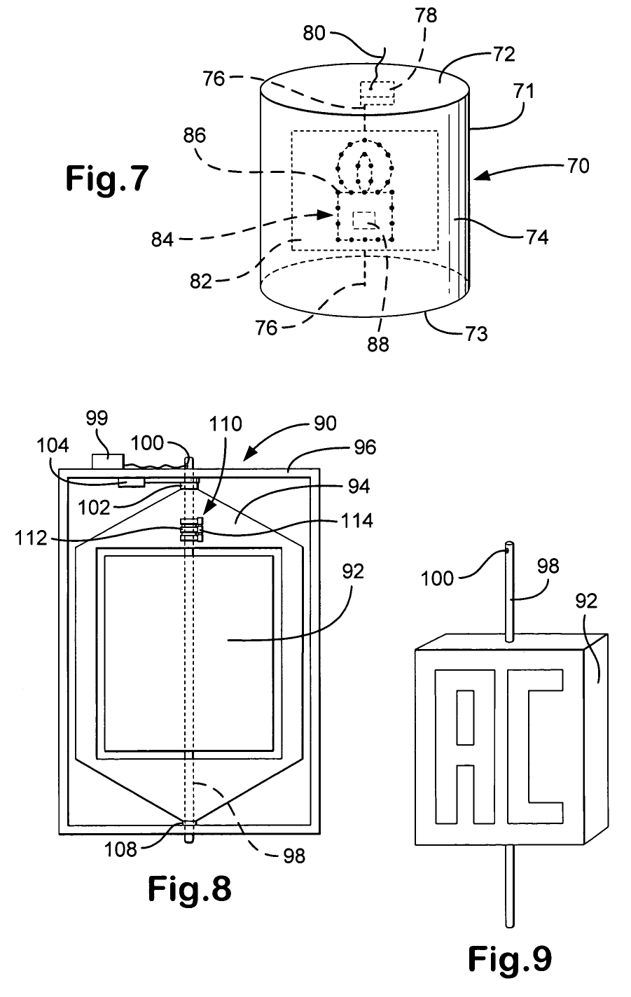

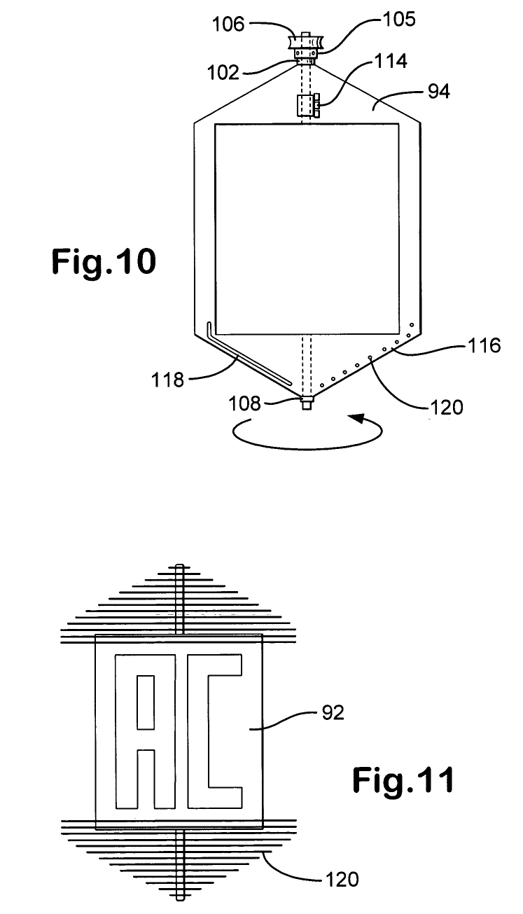

FIG. 7 shows a further embodiment of the invention, for use in areas in which there is no ambient wind. The device 70 comprises a cylindrical frame 71, the top 72 and bottom 74 of the frame being of a solid plastics material and the body 74 of the cylinder being of a clear plastics material. In the centre of the top and bottom are a pair of spindle bearings 76, and on the top is a motor 78 for driving the bearing. A source of electricity 80, generally either the mains or a battery supply, is provided on the top of the frame. Positioned between the spindle bearings and driven thereby, is a display board 82, which is provided as a pcb.

The display board 82 is provided with an image 84 and lights 86 as described above in relation to the other embodiments of the invention. In addition the pcb 80 holds all the circuitry necessary for activation of the lights and animation thereof is requires.

This embodiment is particularly useful for indoor applications. In particular the embodiment can be used as a series of Christmas lights for hanging on a Christmas tree. A series of devices can be strung together in the same manner as Christmas lights, and each board can have an image of a candle, star or present, for example. Each image is provided with lights, and rotation of the board, as provided for by the motor, results in a 3D trace of the lights, as described above. In a further application, a large device could be provided as an artificial Christmas tree. An image of a tree on the board together with appropriate lights, when spinning, would create the illusion of a Christmas tree.

Referring now to FIGS. 8, 9 & 10, in the device 90 shown therein, a central section thereof 92 remains stationary, while an outer section 94 rotates therearound.

In this embodiment, the device 90 includes a frame 96 for holding and supporting the device. The central section 92 is provided as a light box, although other display boards could be used, with or without lights. The central section is connected to the frame by a central shaft 98. As shown the central shaft 98 extends through the light box, but alternatively it could simply be connected at each end thereof. The shaft 98 is hollow and allows power to be supplied to the light box through an opening 100 at the top of the shaft, the power supply 99 for the device being mounted on the frame. The power supply 99 may be a battery, possibly charged from an alternative power supply, or the mains.

The outer section 94, the spinning section, is mounted round the central shaft 98 and is connected thereto by bearings 102, the fixed section thereof being provided on the central shaft and the rotatable section provided on the outer section 94. As shown, the spinning of this device is power driven, but if the device were to be used in an outside position, where there is an ambient wind, it could be unpowered, with the spinning being caused by the wind. In this embodiment, a motor drives the device 90. The motor 104 is mounted on the frame 96 and is a pulley and belt drive type motor, although other types of motor, for example a cogged motor could be used. The bearings 102 on the outer section 94 are provided with a plate 105 for attachment to the motor belt 106, allowing the motor to drive the spinning of the outer section 94. A bearing assembly 108 is also provided at the other end of the outer section 94. This may be an identical bearing to the upper one 102, but may be a different type of bearing assembly, for example a non-ball bearing type assembly.

As in the previous embodiments, the spinning section is provided with lights. To transfer power to the outer section, a slip ring assembly 110 is provided. The slip rings 112 of the assembly 110 are fixed to the central shaft 98 and remain stationary thereon. Bushes 114 of the assembly 110 are connected to the central section 94 and rotate therewith. This provides power to the spinning outer section to power lights 116 provided thereon.

As shown in FIG. 11, as the outer 94 spins it creates the illusion of the central section being surrounded by light traces. If strips 118 of lights are used usually in the form of cold cathode solid lighting, the illusion of a wash of light is created. Alternatively if spotlights, or points of light 120 are used, the illusion of traces surrounding the central section is created. In addition, a sequencer, for animation of the lights is provided on the central section. This requires the slip ring assembly to have several lines of communication, and could be omitted if a simple slip ring assembly were to be used.

The invention is not intended to be restricted to the details of the above-described embodiment. For instance, other images could be provided on the display board and lights could be provided on the frame as well as the display board. In addition, different shapes of inner and outer sections can be provided. For example, both the inner and outer can be circular in shape, clearly with the outer being hollow. Alternatively, the inner could be a rectangle with a hollow diamond shape as the outer.

1. A sign including:
an fixed section including
at least one pair of bearings and
means for attachment to a power supply
a rotatable section having
means for attachment to the bearings on the fixed section, enabling rotation of one section about the other,
lights on the fixed and/or rotatable section(s) being powered from the power supply,
means for supplying power to fixed and/or rotatable section(s).

2. A sign as claimed in claim 1, wherein the means for supplying power to the display board is a slip ring device

3. A sign as claimed in claim 2, wherein an outer section of the slip-ring being attached to the fixed section and power supply thereon and remaining static, and an inner section affixed to the rotatable section and moving therewith

4. A sign as claimed in claim 2, wherein a central slip ring assembly is attached to the fixed section and remains static thereon, while bushes of the slip ring are attached to the rotatable section and rotate therewith.

5. A sign as claimed in claim 1, further including an electronic controller to animate the display lights.

6. A sign as claimed in claim 1, further including a motor for rotation of the rotatable section.

7. A sign as claimed in claim 1, wherein the power is provided from the mains.

8. A sign as claimed in claim 1, wherein the power is provided from an alternative source, such as a solar panel or a dynamo, powered from rotation of the rotatable section.

9. A sign as claimed in claim 8, further including batteries to be charged by the solar panel or dynamo.

10. A sign as claimed in claim 9, further including change over circuitry to change the power source to the mains if the charge on the batteries decreases past a predetermined threshold.

11. A sign as claimed in claim 1, further including a photodiode to detect the ambient light levels, and allow power to pass to the lights only when the light level drops below a certain predetermined threshold.
